(19) United States
(12) Patent Application Publication
(10) Pub. No.: US 2014/0019540 A1
(43) Pub. Date: Jan. 16, 2014

(54) METHOD AND SYSTEM FOR PROVIDING VARIOUS SERVICES BASED ON SOCIAL INFORMATION OF MESSENGER PLATFORM USERS

(71) Applicant: LINE CORPORATION, Tokyo (JP)

(72) Inventors: JungHo SHIN, Seongnam-si (KR); Jungmin Lee, Seongnam-si (KR); Hyun Joo Na, Seongnam-si (KR)

(73) Assignee: LINE CORPORATION, Tokyo (JP)

(21) Appl. No.: 13/730,109

(22) Filed: Dec. 28, 2012

(30) Foreign Application Priority Data
Jul. 13, 2012 (KR) 10-2012-0076490

(51) Int. Cl. H04L 29/08

(52) U.S. Cl. CPC H04L 67/22
USPC 709/204

(57) ABSTRACT

Provided is a method and system for providing various services based on social information of messenger platform users. The method for providing the various services may include: providing a main service using a real profile including social information of users using a main service; and providing a channel for a plurality of inter-operative services through the main service. The at least one of the plurality of inter-operative services may be provided to a user selecting the at least one of the plurality of inter-operative services and at least one other user with whom the user establishes a relationship using the real profile in the at least one of the plurality of inter-operative services.

### CROSS-REFERENCE TO RELATED APPLICATION

This application claims priority from and the benefit of Korean Patent Application No. 10-2012-0076490, filed on Jul. 13, 2012, which is hereby incorporated by reference for all purposes as if fully set forth herein.

### BACKGROUND OF THE INVENTION

1. Field of the Invention

Exemplary embodiments of the present invention relate to a method and system for providing various services based on social information of messenger platform users.

2. Description of Related Art

A messenger service may exchange messages and data essentially in real time on the Internet, enabling responses to be received from another user, as well as an exchange of messages, while working on a computer. Since connectivity to the Internet of the other user may be verified, use of the messenger service is faster than communicating by e-mail. Also, the messenger service may support a group chat and a voice chat, and sending text messages and large volume video files to a mobile phone.

### SUMMARY OF THE INVENTION

Exemplary embodiments of the present invention provide a method and a service platform system for providing a service that may utilize a messenger platform as a social platform, aside from a messenger service through the messenger platform, by installing various services on the messenger platform based on user information and social information such as friends of the messenger platform.

Exemplary embodiments of the present invention also provide a method and service platform system for providing a service that may provide various services through applications created internally or externally, aside from a messenger service through a messenger platform.

Exemplary embodiments of the present invention also provide a method and service platform system for providing a service that may provide a service of an external company through an application created by the external company, provide the service of the external company based on a messenger platform, levy an initial platform admission fee to the external company, or create profits by dividing, between a provider of a messenger service and the external company, profits generated through the service provided to a user by the external company.

Additional features of the invention will be set forth in the description which follows, and in part will be apparent from the description, or may be learned by practice of the invention.

Exemplary embodiments of the present invention disclose a method that uses a processor to perform a service based on social information of a user, the method including: providing a main service using a real profile including the social information of the user using the main service; providing a channel for a plurality of inter-operative services through the main service; and selecting, using the processor, an inter-operative service from the plurality of inter-operative services through the channel. The selected inter-operative service is provided to the user and at least one other user with whom the user establishes a relationship by using the real profile in the selected inter-operative service.

Exemplary embodiments of the present invention disclose a service platform system including: a processor; a main service providing unit configured to provide a main service using a real profile including social information of a user using the main service; and an inter-operative service providing unit configured to provide a channel for a plurality of inter-operative services through the main service, and configured to select, via the processor, an inter-operative service from the plurality of inter-operative services through the channel. The selected inter-operative service is provided to the user and at least one other user with whom the user establishes a relationship by using the real profile in the selected inter-operative service.

Exemplary embodiments of the present invention disclose a non-transitory computer-readable medium including a program storing instructions for a computer system to provide a service, wherein the computer system performs a method including the steps of: providing a main service using a real profile including social information of users using the main service; and providing a channel for a plurality of inter-operative services through the main service, and providing an inter-operative service selected through the channel. The selected inter-operative service is provided to the user and at least one other user with whom the user establishes a relationship by using the real profile in the selected inter-operative service.

Exemplary embodiments of the present invention disclose a method for providing an inter-operative service, the method including: providing a main service using a real profile including social information of users using the main service; providing a channel for a plurality of inter-operative services through the main service; providing a list of the plurality of inter-operative services provided through the channel; and selecting, with a user interface, an inter-operative service from the list. The selected inter-operative service is provided in conjunction with the main service of a service platform.

Exemplary embodiments of the present invention disclose a method performed on a processor for providing an inter-operative service, the method including: providing a main service using a real profile including social information of users using the main service; providing a channel for a plurality of inter-operative services through the main service; providing a list of the plurality of inter-operative services selected through the channel; providing an inter-operative service selected by a user from the list of the plurality of inter-operative services; and providing, on the processor, news information on a user associated with the inter-operative service selected by the user to another user with whom the user establishes a relationship using at least one of the real profile, a profile for each service, and a channel profile.

Exemplary embodiments of the present invention disclose a service platform system including: a main service providing unit configured to provide a main service using a real profile including social information of users using the main service; and an inter-operative service providing unit configured to provide a channel for a plurality of inter-operative services through the main service, and configured to provide an inter-operative service selected by a user from a list of the plurality of inter-operative services by providing the list of the plurality of inter-operative services selected through the channel. The inter-operative service is provided in conjunction with the main service of a service platform

Exemplary embodiments of the present invention disclose a service platform system including: a main service providing unit configured to provide a main service using a real profile including social information of users using the main service; an inter-operative service providing unit configured to provide a channel for a plurality of inter-operative services through the main service, and to provide an inter-operative service selected by a user from a list of the plurality of inter-operative services by providing the list of the plurality of inter-operative services selected through the channel; and a news information providing unit configured to provide news information on the user associated with the inter-operative service selected by the user, using at least one of the real profile, the profile for each service, and the channel profile to another user with whom the user establishes a relationship.

Information for providing a method and system for providing various services based on social information of messenger platform users may be stored in a server computer readable recording medium. The recording medium may include all kinds of recording media in which a program and data are stored so as to be readable by a computer system. The recording medium may include a read only memory (ROM), a random access memory (RAM), a compact disk (CD), a digital video disk (DVD) ROM, a magnetic tape, a floppy disk, an optical data storage, or the like, and a medium implemented in a form of a carrier wave (for example, transmission through the Internet). The recording medium may be distributed in a computer system connected by a network, such that a computer readable code may be stored and executed in a distributed scheme.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a screen providing various services through a channel based on a messenger platform according to exemplary embodiments of the present invention.

FIG. 2 illustrates an internal configuration of a service platform system according to exemplary embodiments of the present invention.

FIG. 3 illustrates a real graph of a messenger service used in a schedule service according to exemplary embodiments of the present invention.

FIGS. 4 and 5 illustrate providing a schedule service to another user according to exemplary embodiments of the present invention.

FIG. 6 illustrates a method for providing a service according to exemplary embodiments of the present invention.

FIGS. 7 and 8 illustrate a main service and an inter-operative service being switched according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. It should be understood that position and arrangement of individual components in each disclosed exemplary embodiment may be changed without departing from the spirit and the scope of the present invention. Therefore, a detailed description described below should not be construed as being restrictive. The scope of the present invention is defined only by the accompanying claims and their equivalents if appropriate. Similar reference numerals will be used to describe the same or similar functions throughout the accompanying drawing.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

It will be understood that when an element is referred to as being “connected to” another element, it can be either directly connected to the other element or intervening elements may be present.

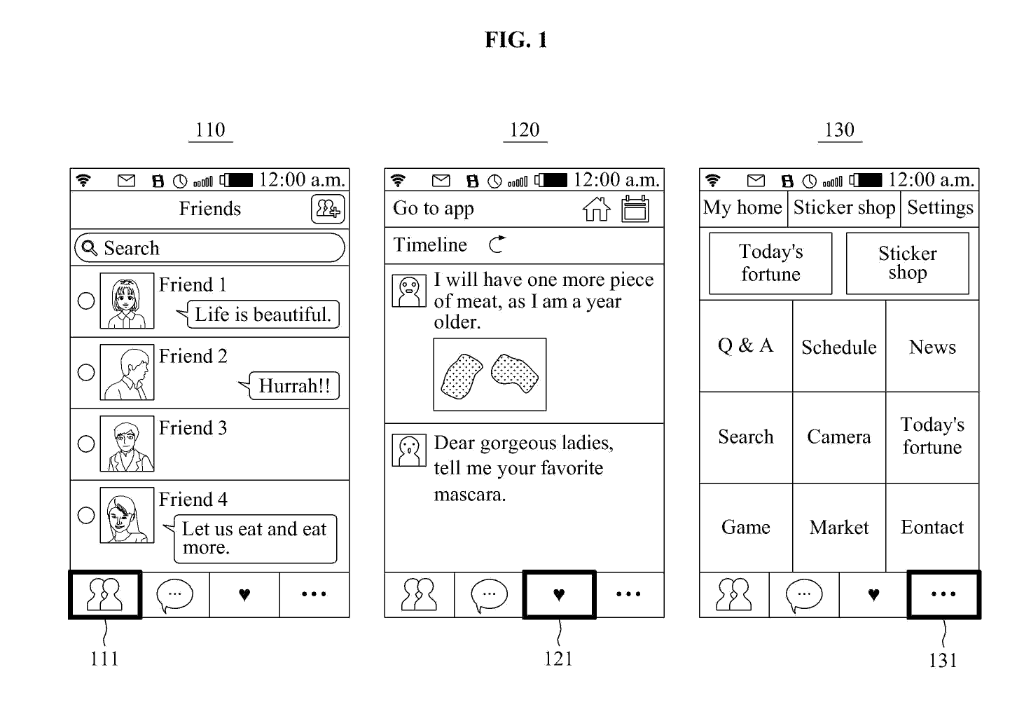

FIG. 1 illustrates a screen providing various services through a channel based on a messenger platform according to exemplary embodiments of the present invention.

A first screen 110 of a terminal screen can display a list of friends of a messenger service. The first screen 110 displays an activation of a user interface 111 for displaying the list of friends.

A second screen 120 of a terminal screen can display a timeline. The second screen 120 displays an activation of a user interface 121 for displaying a timeline. “Timeline” may refer to news information on friends associated with various services provided through the messenger service. The timeline information may be displayed chronologically. For example, a record of contents usage or activity of friends may be provided in a form of an alarm through the timeline. Varied information such as a user name, the record of activity, a contents detail, a comment, and the like, may be displayed chronologically through the timeline.

A third screen 130 of a terminal screen can display a list of applications that are created internally or externally. External applications can be based on an internally prescribed principle and policy. The third screen 130 displays an activation of a user interface 131 for displaying the list of applications. For example, a channel for providing various inter-operative services through the messenger service may be provided, and a user may select and use a desired inter-operative service through the channel.

FIG. 1 illustrates an example of providing a channel through a messenger service for a plurality of inter-operative services in which an application may refer to an application created by a provider internal or external to the company providing the messenger service. The externally developed application created may be provided under permission from the messenger platform provider.

External applications may be created for various services such as a game, an event, a community, a schedule, and the like. External applications may be provided in a form of a web application operated as an application for the messenger service, or may be provided in a form of a native application operated separately from the application for the messenger service.

When a user selects a native application and the application is installed on a terminal, the user may connect to a corresponding inter-operative service. In some embodiments, when the application is absent from the terminal, download assistance information for the application may be provided to the user.

An inter-operative service may be provided to at least two users between whom a relationship is established using social information of users using the messenger service. The inter-operative service using the social information of the messenger service may be provided in lieu of any other random service, through the messenger service. The list of friends of the messenger service may be utilized in an inter-operative service, such as, a game service, a schedule service, a today's fortune service, and the like. Using service, for example, today's fortune, with a friend of the user, and transferring information, for example, in a schedule service transferring a schedule of the user to the friend, and the like, may be made possible in the messenger service.

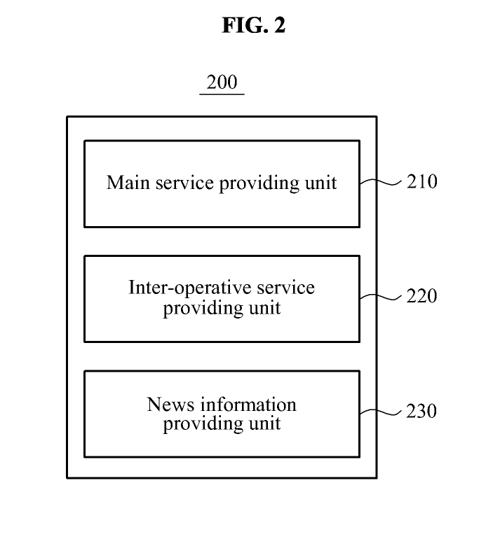

FIG. 2 illustrates an internal configuration of a service platform system 200 according to exemplary embodiments of the present invention. The service platform system 200 may provide a main service such as a message service described in FIG. 1. The main service may not be limited to the message service. Other social networking services in which a social relationship is established and managed may be included in the main service.

The service platform system 200 may include a main service providing unit 210 and an inter-operative service providing unit 220. The service platform system 200 may selectively include a news information providing unit 230.

The main service providing unit 210 may provide the main service using a real profile including social information of users using the main service. For example, a service in which a social relationship among users may be established and managed such as a messenger service or a social networking service may be provided to the users as the main service.

The inter-operative service providing unit 220 may provide a channel for a plurality of inter-operative services through the main service, and may provide an inter-operative service selected through the channel. At least one of the plurality of inter-operative services may be provided to a user selecting the at least one of the plurality of inter-operative services and at least one other user with whom the user establishes a relationship using the real profile in the at least one of the plurality of inter-operative services. For example, when the main service is a messenger service, and a user selects a schedule service through the messenger service, the user may transfer or share a schedule with the friend, by locating the friend from a list of friends of the messenger service in the schedule service.

In particular, the at least one of the plurality of inter-operative services may select data associated with the predetermined user in the at least one of the plurality of inter-operative services, and transfer the data to another user with whom the predetermined user establishes a relationship using the real profile through the main service or share the data with the other user. For example, calendar data or schedule data of a user A may be transferred to or shared with another user through the main service. Here, the other user may verify the data transferred to or shared via an identical inter-operative service or be provided with such data through the aforementioned timeline.

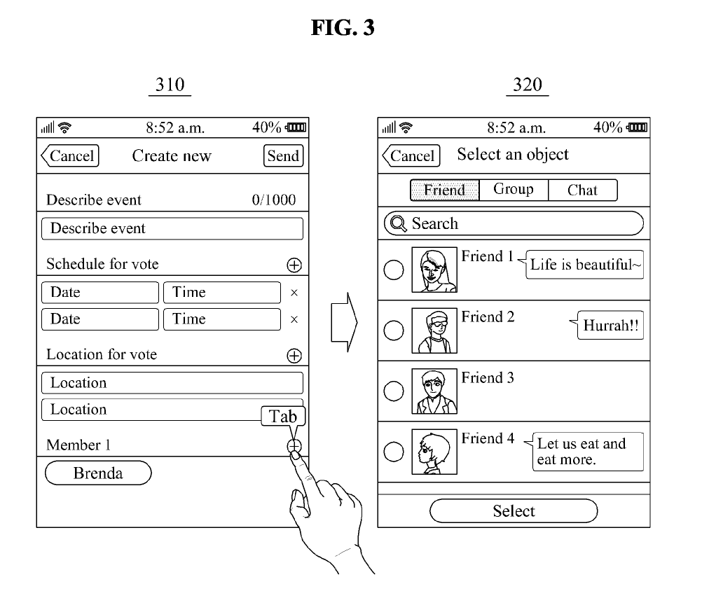

FIG. 3 illustrates a real graph of a messenger service used in a schedule service according to exemplary embodiments of the present invention.

A first screen 310 illustrates a schedule service selected by a user. More particularly, the first screen 310 displays a user tapping a user interface to add a member in the schedule service.

A second screen 320 displays a screen importing a list of friends of a messenger service using a real profile of the messenger service in the schedule service when the user taps the user interface to add the member on the first screen 310.

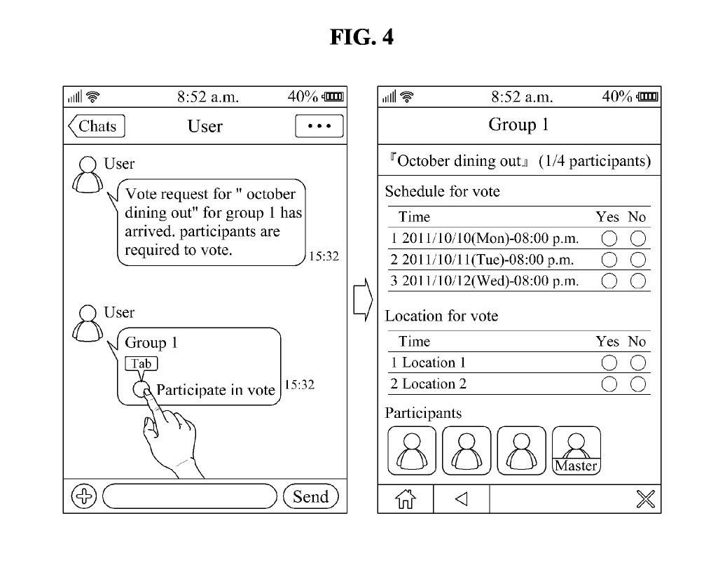

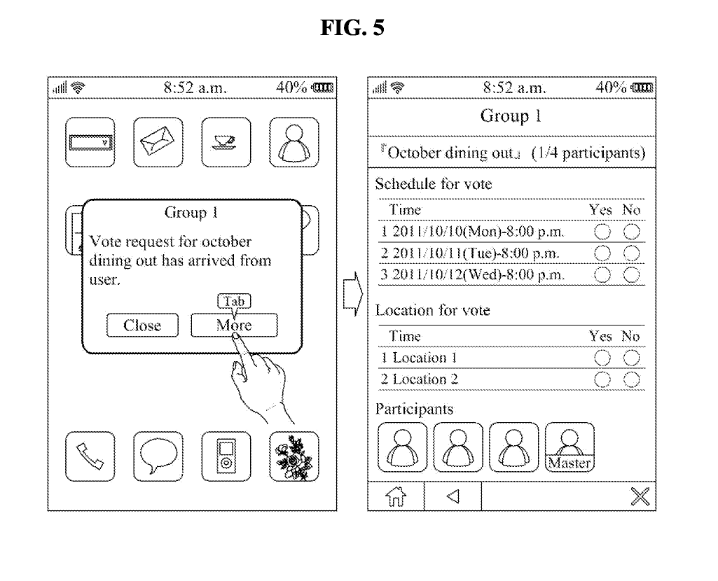

FIGS. 4 and 5 illustrate providing a schedule service to another user according to exemplary embodiments of the present invention. FIG. 4 illustrates an example in which data associated with a schedule is transferred to an added member through a chat room of a messenger service when the user of FIG. 3 adds a member using a real profile and transfers the data associated with the schedule to the added member. The schedule transferred by the chat service is illustrated by the screen titled “Group 1.” FIG. 5 illustrates an example in which the data associated with the schedule is transferred to the added member through a push alarm. The push alarm is illustrated by the pop-up “Group 1” including a button labeled “More;” the schedule information is displayed in the second screen of FIG. 5.

As described in FIGS. 3 to 5, connections to other users may be established by a plurality of inter operative services, such as, chat group and push alarm. The at least one of the plurality of inter-operative services provided through the main service may be provided to a user selecting the at least one of the plurality of inter-operative services and at least one other user with whom the user establishes a relationship using a real profile in the at least one of the plurality of inter-operative services.

Referring to FIG. 2, at least one of the plurality of inter-operative services may utilize a profile for each service or a channel profile. Here, the profile for each service may include social information of users using the at least one of the plurality of inter-operative services, and the channel profile may include social information of users using the channel. Here, the profile for each service may refer to a profile in each of the plurality of inter-operative services, and the channel profile may refer to a profile used commonly throughout a total of channels.

For example, when a chat service is provided as an inter-operative service, the chat service may be provided using a profile managed internally by the chat service, rather than the real profile of the main service.

Additionally, inter-operative services that do not need to be operated in conjunction with another user such as a housekeeping book service, a dictionary service, and the like, may not use such profiles.

The news information providing unit 230 may provide news information on users associated with a plurality of inter-operative services using at least one of a real profile, a profile for each service, and a channel profile, to other users with whom the users establish a relationship. Here, the news information may include a record of contents usage, activity, and the like.

The plurality of inter-operative services may be provided to a user terminal based on a service platform of a main service, and provided through different applications being operated on the user terminal. Each of the plurality of inter-operative services may be provided through an application separate from an application for providing a main service.

Here, an application for inter-operative services may be provided in the following two forms: (1) In a form of a web application operated in a main application for providing a main service, or (2) In a form of a native application operated separately from a main application. For example, a portion of the plurality of inter-operative services may be provided through the application created in the form of the web application operated in a browser on the main application for the main service, without downloading an application program. In some embodiments, one or more of the plurality of inter-operative services may be provided through an application created in the form of the native application operated by being installed on a user terminal.

The plurality of inter-operative services may include an internal service of a provider providing the main service, as well as an external service of an external company. For example, at least one service of an external company among the plurality of inter-operative services may either be provided on the service platform of the main service, or may either be provided through an application created by the external company. The application created by the external company may also be as a web application or a native application.

An initial platform admission fee may be levied to the external company for displaying a service of the external company through a channel. In some embodiments, a profit generated through the service provided by the external company may be divided between a provider of the main service and the external company. For example, when a today's fortune service is provided by being installed in a main service platform, and a user of the main service platform uses the today's fortune service at a fee, a profit may be divided in a proportion between a company providing the today's fortune service and a company providing the service platform. Profits generated through an item purchased in a game service or inter-operative services may be similarly divided between a company providing an inter-operative service and a company providing the service platform.

A provider of the main service may attract user attention and drive traffic by providing various services provided by an external company in conjunction with services created internally. The external company may obtain a relatively easier access to advertise services of the external company to the users. The provider of the main service may generate additional profits by levying an initial platform admission fee or receiving a share of a service profit, in lieu of providing the service of the external company through the main service.

The inter-operative service providing unit 220 may provide the main service by switching to an inter-operative service selected by a user. In this instance, the inter-operative service may include a user interface for reverting to the main service. For example, the service platform system 200 may provide the main service and the inter-operative service by switching the main service and the inter-operative service. Such switching may be made possible by a plurality of inter-operative services being created based on an internally prescribed developer principle or policy.

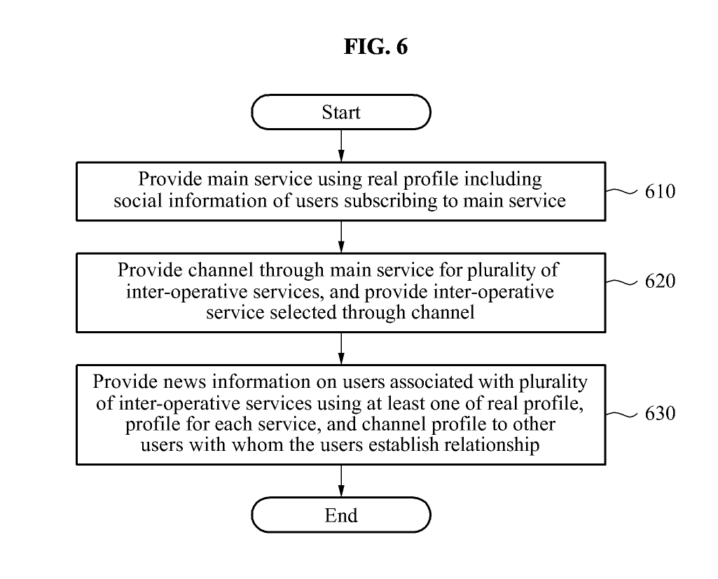

FIG. 6 is a flowchart illustrating a method for providing a service according to exemplary embodiments of the present invention. The method for providing the service may be conducted by the service platform system 200 of FIG. 2.

In operation 610, the service platform system 200 may provide a main service using a real profile including social information of users using the main service. For example, a service such as a messenger service or a social networking service in which a social relationship among users may be established and managed may be provided to the users as the main service.

In operation 620, the service platform system 200 may provide a channel for a plurality of inter-operative services through the main service. Here, at least one of the plurality of inter-operative services may be provided to a user selecting the at least one of the plurality of inter-operative services and at least one other user with whom the user establishes a relationship using the real profile in the at least one of the plurality of inter-operative services. For example, when the main service is a messenger service, and a user selects a service through the messenger service, the user may transfer a schedule of the user to a friend or share the schedule with the friend using a list of friends of the messenger service in the schedule service.

The at least one of the plurality of inter-operative services may be transferred to or shared with a user with whom the predetermined user establishes a relationship using the real profile by selecting data associated with the user in the at least one of the plurality of inter-operative services. For example, calendar data or schedule data of a user A may be transferred to or shared with another user through the main service. Transitively, the other user may also verify the data transferred or shared through an identical inter-operative service, or be provided with such data through the aforementioned timeline.

Other inter-operative services may utilize a profile for each service or a channel profile. As an example, the profile for each service may include social information of users using a corresponding inter-operative service, and the channel profile may include social information of users using the channel. The profile for each service may indicate a profile for each of the plurality of inter-operative services, and the channel profile may indicate a profile used throughout a plurality of channels.

For example, when a chat service is provided as an inter-operative service, the chat service may be provided using a profile managed internally in the chat service rather than using a real profile of a main service of the chat service.

Additionally, inter-operative services that do not need to be operated in conjunction with another user, such as a housekeeping book service or a dictionary service may not use such profiles.

In operation 630, the service platform system 200 may provide news information on users associated with a plurality of inter-operative services to other users with whom the users establish a relationship using at least one of a real profile, a profile for each service, and a channel profile. The news information may include a record of contents usage or activity of friends, and the like.

The plurality of inter-operative services may be provided to a user terminal based on a service platform of a main service, and provided through different applications being operated on the user terminal. As described above, each of the plurality of inter-operative services may be provided through an application separate from an application for providing a main service.

Here, an application for inter-operative services may be provided in the following two forms: (1) as a web application operated in a main application for providing a main service; and (2) as a native application operated separately from a main application. For example, a portion of the plurality of inter-operative services may be provided through the application created as the web application operated in a browser on the main application for the main service, absent downloading a separate application program. Remaining services among the plurality of inter-operative services may be provided through an application created as the native application operated by being installed separately on a user terminal.

The plurality of inter-operative services may include an internal service of a provider providing the main service, as well as an external service of an external company. As an example, at least one service of an external company among the plurality of inter-operative services may be provided to the user terminal based on the service platform of the main service, and provided through an application created by the external company. The application created by the external company may also be created in one of the aforementioned forms of the web application or the native application.

An initial platform admission fee may be levied to the external company in relation to a service of the external company being displayed through a channel. A profit generated through the service provided to the user by the external company may be divided between a provider of the main service and the external company. For example, when today's fortune service is installed in a main service platform, and a user of the mains service platform uses the today's fortune service at a predetermined fee, a profit may be divided in a predetermined proportion between a company providing the today's fortune service and a company providing the service platform providing company. Profits generated through an item purchased in a game service or inter-operative services, aside from the today's fortune service may be divided between a company providing the inter-operative service and a company providing the service platform.

For example, a provider of the main service may attract attention from users and drive traffic by providing various services provided by an external company aside from services created internally, and the external company may obtain a relatively easier access to advertise services of the external company to the users. The provider of the main service may generate an additional profit by levying an initial platform admission fee or receiving a service profit divided, in lieu of providing the service of the external company through the main service.

In operation 620, the service platform system 200 may provide the main service by switching to an inter-operative service selected by a user. In this instance, the inter-operative service may include a user interface for reverting to the main service. The service platform system 200 may provide the main service and the inter-operative service by switching the main service and the inter-operative service. Such switching may be made possible by a plurality of inter-operative services being created based on an internally prescribed developer principle or policy.

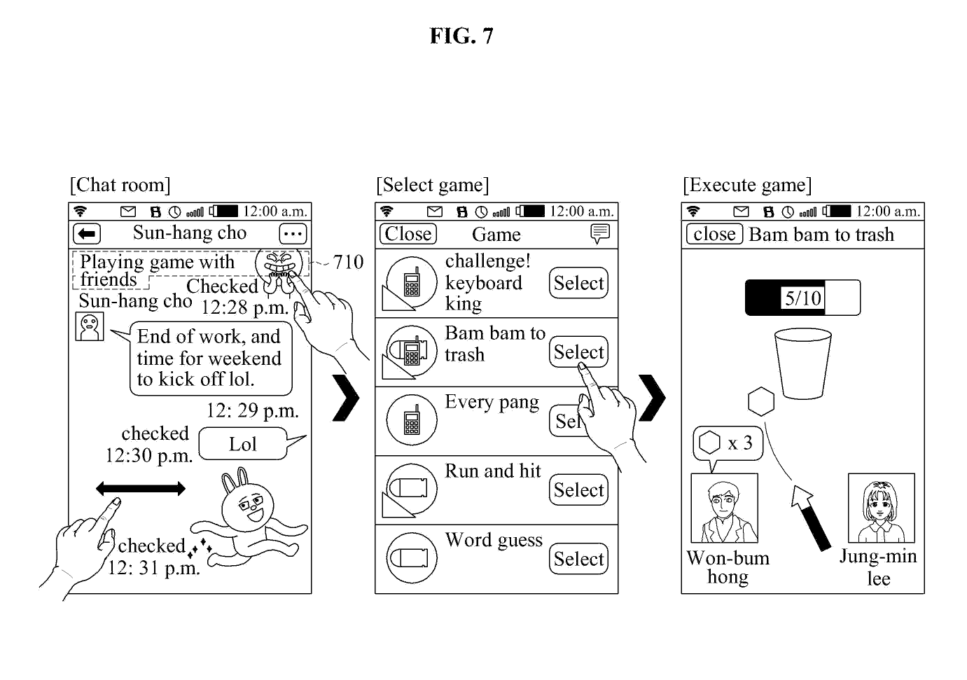

FIG. 7 illustrates a main service and an inter-operative service being switched according to exemplary embodiments of the present invention. A user interface 710 for receiving a list of game services through a banner or a promotion area on a chat screen is provided. When a user interface area represented as a dotted box is tapped by a user, a list of various game services may be provided to the user. When the user selects a predetermined game service, a messenger service may be switched to a corresponding game service and the game service selected may be provided to the user.

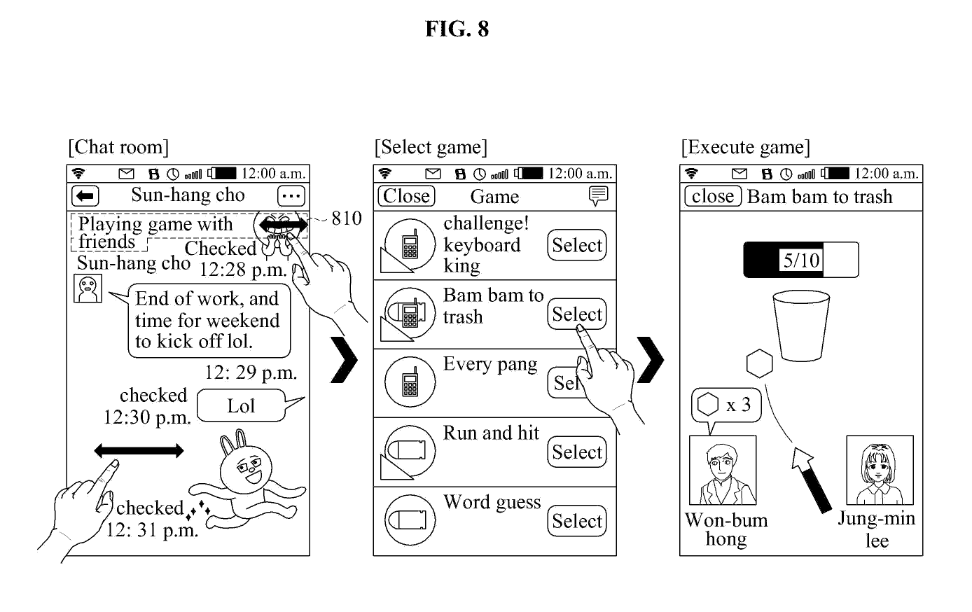

FIG. 8 illustrates a method for inter-operating in conjunction with a game on a chat screen according to exemplary embodiments of the present invention. A user interface for receiving a list of game services is provided through a user event 810 such as clicking on or flicking through a banner on an upper portion of a chat screen, flicking through the chat screen to right or left, and the like. A dotted box area may correspond to the banner in the upper portion of the chat screen.

A channel may be provided through various user events in a main service, and when an inter-operative service is selected in the channel, the main service may be provided by switching to the inter-operative service. The inter-operative service may include a user interface for reverting to the main service. For example, as shown in FIGS. 7 and 8, users exchanging chat messages through a messenger service may be provided with a game service by selecting the game service, and return to an original chat screen to be provided via the messenger service.

According to exemplary embodiments of the present invention, a messenger platform can be used as a social platform based on user information and social information, such as, friends of the messenger platform, by installing a variety of services on the messenger platform.

According to exemplary embodiments of the present invention various services through applications created internally or externally can be provided.

According to exemplary embodiments of the present invention, a service of an external company through an application created by the external company, based on a messenger platform, can levy an initial platform admission fee to the external company. A service can generate profits by dividing profits, between a provider of a messenger service and the external company, generated through the service provided to a user by the external company.

At least one other inter-operative service of the plurality of inter-operative services may be provided to at least two users establishing a relationship, using at least one of a profile for each service including the social information of the at least two users selecting the at least one other inter-operative service or a channel profile including social information of the at least two users using the channel.

The service may provide news information on users associated with the plurality of inter-operative services, using at least one of the real profiles, the profile for each service, and the channel profile to other users with whom the users establish a relationship.

The plurality of inter-operative services may be provided to a user terminal based on a service platform of the main service, and is provided through different applications being operated on the user terminal.

An application for providing at least one of the plurality of inter-operative services may be created to be operated in a main application in which the main service is provided.

At least one service of a company external to a main service provider among the plurality of inter-operative services may be provided to a user terminal based on a service platform of the main service, and provided to the user terminal through an application created by the external company.

An initial platform admission fee may be levied to the external company in relation to the service provided by the external company being displayed through the channel.

A profit generated through the service provided to a user by the external company may be divided between a provider of the main service and the external company.

The providing of the inter-operative service selected through the channel may include providing the main service by switching to the selected inter-operative service, and the inter-operative service includes a user interface for reverting from the selected inter-operative service to the main service.

The providing of the inter-operative service selected through the channel may include selecting data associated with the inter-operative service selected by a user, and transferring the selected data to another user with whom a relationship is established using the real profile through the main service or sharing the selected data with the other user.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to perform a service based on social information of a user, the method comprising:
providing a main service using a real profile comprising the social information of the user using the main service;
providing a channel for a plurality of inter-operative services through the main service; and
selecting, using the processor, an inter-operative service from the plurality of inter-operative services through the channel,
wherein the selected inter-operative service is provided to the user and at least one other user with whom the user establishes a relationship by using the real profile in the selected inter-operative service.

2. The method of claim 1, wherein at least one other inter-operative service of the plurality of inter-operative services is provided to at least two users establishing a relationship, using at least one of a profile for each service comprising social information of the at least two users selecting the at least one other inter-operative service or a channel profile comprising social information of the at least two users using the channel.

3. The method of claim 2, further comprising:
providing news information on users associated with the plurality of inter-operative services, using at least one of the real profile, the profile for each service, and the channel profile to other users with whom the user establishes a relationship.

4. The method of claim 1, wherein the plurality of inter-operative services are provided to a user terminal, and the plurality of inter-operative services are provided through different applications being operated on the user terminal,
wherein the inter-operative service is provided in conjunction with the main service of a service platform.

5. The method of claim 4, wherein an application for providing at least one of the plurality of inter-operative services is operated in a main application comprising the main service.

6. The method of claim 1, wherein the plurality of inter-operative services comprise at least one external company service that is provided to a user terminal, and the at least one an external company service is provided to the user terminal through an application created by the external company,
wherein the at least one external company service is provided in conjunction with the main service of a service platform.

7. The method of claim 6, further comprising levying an initial platform admission fee to the external company in relation to the external company service being displayed through the channel.

8. The method of claim 6, further comprising dividing a profit generated through the external company service between a provider of the main service and the external company.

9. The method of claim 1, wherein the selecting further comprises:
providing the main service by switching to the selected inter-operative service, and
the selected inter-operative service comprises a user interface for reverting from the selected inter-operative service to the main service.

10. The method of claim 1, wherein the selecting further comprises:
selecting data associated with the selected inter-operative service, and transferring the selected data to another user with whom a relationship is established using the real profile through the main service or sharing the selected data with the other user.

11. A service platform system comprising:
a processor;
a main service providing unit configured to provide a main service using a real profile comprising social information of a user using the main service; and
an inter-operative service providing unit configured to provide a channel for a plurality of inter-operative services through the main service, and configured to select, via the processor, an inter-operative service from the plurality of inter-operative services through the channel,
wherein the selected inter-operative service is provided to the user and at least one other user with whom the user establishes a relationship by using the real profile in the selected inter-operative service.

12. The service platform system of claim 11, wherein at least one other inter-operative service of the plurality of inter-operative services is provided using at least one of a profile for each service comprising social information of at least two users selecting the at least one other inter-operative service or a channel profile comprising social information of the at least two users using the channel, to the at least two users between whom a relationship is established through the profile for each service or the channel profile, respectively.

13. The service platform system of claim 12, further comprising:
a news information providing unit to provide news information on users associated with the plurality of inter-operative services, using at least one of the real profile, the profile for each service, and the channel profile to users between whom the user establishes a relationship.

14. The service platform system of claim 11, wherein the plurality of inter-operative services is provided to a user terminal comprising a service platform of the main service, and the plurality of inter-operative services is provided through different applications being operated on the user terminal.

15. The service platform system of claim 14, wherein an application for providing at least one of the plurality of inter-operative services is operated in a main application comprising the main service.

16. The service platform system of claim 11, wherein the plurality of inter-operative services comprise at least one external company service that is provided to a user terminal comprising a service platform of the main service, and the at least one external company service is provided to the user terminal through an application created by the external company.

17. The service platform system of claim 16, wherein an initial platform admission fee is levied to the external company in relation to the external company service being displayed through the channel.

18. The service platform system of claim 16, wherein a profit generated through the external company service is divided between a provider of the main service and the external company.

19. A non-transitory computer-readable medium comprising a program storing instructions for a computer system to provide a service, wherein the computer system performs a method comprising the steps of:
providing a main service using a real profile comprising social information of users using the main service; and
providing a channel for a plurality of inter-operative services through the main service, and providing an inter-operative service selected through the channel,
wherein the selected inter-operative service is provided to the user and at least one other user with whom the user establishes a relationship by using the real profile in the selected inter-operative service.

20. A method for providing an inter-operative service, the method comprising:
providing a main service using a real profile comprising social information of users using the main service;
providing a channel for a plurality of inter-operative services through the main service;
providing a list of the plurality of inter-operative services provided through the channel; and
selecting, with a user interface, an inter-operative service from the list,
wherein the selected inter-operative service is provided in conjunction with the main service of a service platform.

21. The method of claim 20, wherein the selected inter-operative service comprises a web application operated in a main application for providing the main service.

22. The method of claim 20, wherein the selected inter-operative service comprises a native application operated separately from a main application for providing the main service.

23. The method of claim 22, wherein the selecting, with the user interface, of the inter-operative service comprises:
verifying presence of the native application; and
providing the inter-operative service after verifying presence.

24. The method of claim 22, wherein the selecting, with the user interface, of the inter-operative service comprises:
verifying presence of the native application; and
providing download assistance information for the native application when the native application is verified to be absent on the user terminal.

25. The method of claim 20, wherein the selecting, with the user interface, of the inter-operative service comprises:
providing the inter-operative service to the user and at least one other user with whom the user establishes a relationship using at least one of a real profile, a profile for each service and a channel profile.

26. The method of claim 20, wherein the selecting, with the user interface, of the inter-operative service comprises:
providing news information on the user about the inter-operative service to at least one other user with whom the user establishes a relationship using at least one of a real profile, a profile for each service and a channel profile.

27. The method of claim 26, wherein the news information comprises a record of usage or activity of the user with respect to the inter-operative service.

28. The method of claim 20, wherein among the plurality of inter-operative services comprise at least one external company service provided to a terminal, and the at least one external company service is provided to the terminal through an application created by the external company,
wherein the at least one external company service is provided in conjunction with the main service of a service platform.

29. The method of claim 28, wherein a profit generated through the external company service is divided between a provider of the main service and the external company.

30. A method performed on a processor for providing an inter-operative service, the method comprising:
providing a main service using a real profile comprising social information of users using the main service;
providing a channel for a plurality of inter-operative services through the main service;
providing a list of the plurality of inter-operative services selected through the channel;
providing an inter-operative service selected by a user from the list of the plurality of inter-operative services; and
providing, on the processor, news information on a user associated with the inter-operative service selected by the user to another user with whom the user establishes a relationship using at least one of the real profile, a profile for each service, and a channel profile.

31. The method of claim 30, wherein the inter-operative service selected by the user is a native application operated separately from a main application for providing the main service.

32. The method of claim 31, wherein the providing of the inter-operative service selected by the user comprises:
verifying a presence of the native application on a terminal; and
providing the inter-operative service when the native application presence is verified.

33. The method of claim 31, wherein the providing of the inter-operative service selected by the user comprises:
verifying a presence of the native application on a terminal; and
providing download assistance information for the native application when the native application is verified to be absent.

34. The method of claim 30, wherein the providing of the inter-operative service selected by the user comprises:
providing the inter-operative service to the user and at least one other user with whom the user establishes a relationship using a real profile comprising social information of the user.

35. The method of claim 30, wherein the news information comprises a record of usage or activity of the user with respect to the inter-operative service.

36. The method of claim 30, wherein the plurality of inter-operative services comprises at least one external company service provided in a terminal, and the at least one external company service is provided to the terminal through an application created by the external company,
wherein the at least one external company service is provided in conjunction with the main service of a service platform.

37. The method of claim 36, wherein a profit generated through the external company service is divided between a provider of the main service and the external company.

38. A service platform system comprising:
a main service providing unit configured to provide a main service using a real profile comprising social information of users using the main service; and
an inter-operative service providing unit configured to provide a channel for a plurality of inter-operative services through the main service, and configured to provide an inter-operative service selected by a user from a list of the plurality of inter-operative services by providing the list of the plurality of inter-operative services selected through the channel,
wherein the inter-operative service is provided in conjunction with the main service of a service platform.

39. A service platform system comprising:
a main service providing unit configured to provide a main service using a real profile comprising social information of users using the main service;
an inter-operative service providing unit configured to provide a channel for a plurality of inter-operative services through the main service, and to provide an inter-operative service selected by a user from a list of the plurality of inter-operative services by providing the list of the plurality of inter-operative services selected through the channel; and
a news information providing unit configured to provide news information on the user associated with the inter-operative service selected by the user, using at least one of the real profile, the profile for each service, and the channel profile to another user with whom the user establishes a relationship.
